(19) United States
(12) Patent Application Publication
(10) Pub. No.: US 2010/0273953 A1
(43) Pub. Date: Oct. 28, 2010

(54) FUNCTIONALIZED POLYARYL ETHERS

(75) Inventors: Martin Weber, Maikammer (DE); Yohannes Ervan Santoso, Bandung (ID)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/831,652

(22) Filed: Jul. 7, 2010

Related U.S. Application Data
(63) Continuation of application No. 11/329,080, filed on Jan. 11, 2006, now abandoned.

(30) Foreign Application Priority Data
Jan. 12, 2005 (DE) 10 2005 001 599.9

(51) Int. Cl. C08G 65/00; C08L 81/06; C08L 79/08; C08L 77/00

(52) U.S. Cl. 525/418; 528/171; 528/125

(57) ABSTRACT

Branched polyaryl ether copolymers which are made up of the building blocks of the general formulae I and II

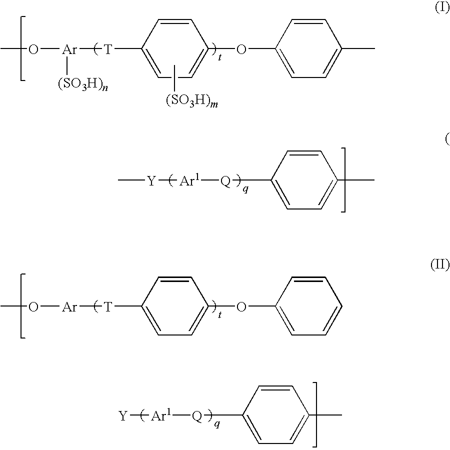

where
t, q: independently of one another, 0, 1, 2 or 3,
m: from 0 to 4,
n: from 1 to 4,
Q, T, Y: independently of one another, each a chemical bond or group selected from among —O—, —S—, —SO₂—, S═O, C═O, —N═N—, —R^{a}C═CR^{b}, —CR^{c}R^{d}—,
Ar, Ar¹: independently of one another, a C₆—C₁₈-aryl group which may be substituted by C₁—C₁₂-alkyl, C₆—C₁₈-aryl or C₁—C₁₂-alkoxy groups or halogen atoms,

and, in addition, comprise from 0.1 to 10% by weight, based on the total weight of the copolymer, of building blocks B which are derived from compounds having at least three hydroxy functions, a process for preparing polyaryl ether copolymers, polymer blends comprising at least one polyaryl ether copolymer and membranes comprising at least one polyaryl ether copolymer.

The present invention relates to functionalized, branched polyaryl ether copolymers, a process for preparing them, polymer blends comprising these copolymers, the use of polyaryl ether copolymers for producing membranes and membranes comprising at least one such copolymer.

Polyaryl ethers belong to the group of high-performance thermoplastics and, owing to their high heat distortion resistance and resistance to chemicals, are used in high-stress applications, cf. G. Blinne, M. Knoll, D. Müller, K. Schlichting, Kunststoffe 75, 219 (1985), E. M. Koch, H.-M. Walter, Kunststoffe 80, 1146 (1990) and D. Döring, Kunststoffe 80, 1149 (1990).

EP 0 855 428 A1 discloses thermoplastic molding compositions which have a reduced water absorption and comprise a linear polyaryl ether comprising sulfone groups in addition to a functionalized polyolefin rubber and at least one modified carboxyl-comprising polyaryl ether. The reduced water absorption is due to a low hydrophilicity.

EP 0 029 633 discloses linear polyaryl ether sulfone copolymers made up of phenyl rings which are linked by ether or sulfone groups. Particular phenyl rings are substituted by from 1 to 4 suffone groups. EP 0 029 633 also discloses a process for preparing these sulfonated polyaryl ether sulfone copolymers by reacting the corresponding polyaryl ethers with concentrated sulfuric acid. The linear polyaryl ether sutfone copolymers have an only unsatisfactory mechanical strength for many applications.

DE 2 305 413 discloses branched, high molecular weight, soluble, thermoplastic, aromatic polyaryl ether sulfones made up of aromatic dialkali metal bishydroxylates, bis(4-haloaryl) compounds whose aryl rings are joined by sulfonyl groups and aromatic alkali metal hydroxylates and/or haloaryl compounds which have at least three functional groups, alkali metal hydroxide or halogen functions. DE 2 305 413 discloses that films comprising these copolymers have an improved tear strength, an improved resistance to unsaturated polyester resins and a reduced combustibility. Owing to the absence of hydrophilic sulfonic acid groups, polyaryl ether sulfone copolymers as described in DE 2 305 413 have a low hydrophilicity.

DE 101 49 871 A1 discloses a thermoplastic molding composition based on branched polyaryl ether sulfones which has an improved melt stability. The branched polyaryl ether sulfones are obtained by a particular proportion of the bifunctional hydroxyl building blocks in linear polyaryl ether sulfones being replaced by units derived from 1,1,1-tris(4-hydroxypheny)ethane. Owing to the absence of hydrophilic functional groups, the polyaryl ether sulfones have a low hydrophilicity.

The polyaryl ether sulfones disclosed in the documents cited, have either a sufficiently high hydrophilicity combined with unsatisfactory mechanical strength or a satisfactory mechanical strength combined with insufficient hydrophilicity.

Owing to their good hydrolysis resistance, based on their low hydrophilicity, polyaryl ethers have for many years been used as membrane materials. Thus, for example, S. Savariar et al., Desalination 144 (2002), 15 to 20, describe the use of polysulfone for producing dialysis membranes. Since polysulfone absorbs relatively little water, a hydrophilic polymer, for example polyvinylpyrrolidone (PVP), is customarily used as additive in the production of such dialysis membranes. In the production of such membranes, the use of additives constitutes a further costly process step.

Functionalization of polyaryl ethers, for example by means of sulfonic acid groups, likewise enables the hydrophilicity of the polyaryl ethers to be increased significantly. Such products are, for example, of interest as membranes for fuel cells.

Apart from the swelling and conductivity, the mechanical strength is also of importance for use as membranes in fuel cells, since considerable forces act on the membranes when the membrane is clamped in the fuel cell. However, the mechanical strength is also influenced by the water absorption, since the water taken up acts as plasticizer and reduces the strength of the membrane. It has hitherto not been possible to provide membranes which have a high mechanical strength combined with a high hydrophilicity.

It is an object of the present invention to provide polyaryl ether copolymers which have not only a high hydrophilicity but also a high mechanical strength.

This object is achieved by branched polyaryl ether copolymers which are made up of the building blocks of the general formulae I and II

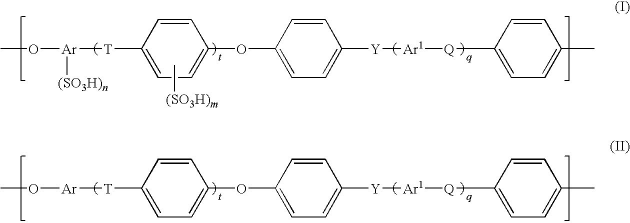

where
t, q: independently of one another, 0, 1, 2 or 3,
m: from 0 to 4,
n: from 1 to 4,
Q, T, Y: independently of one another, each a chemical bond or group selected from among —O—, —S—, —SO₂, S═O, C═O, —N═N—, —R^{a}C═CR^{b}, —CR^{c}R^{d}, where R^{a} and R^{b} are each, independently of one another, a hydrogen atom or a C₁—C₁₂-alkyl group and R^{c} and R^{d} are each, independently of one another, a hydrogen atom or a C₁—C₁₂-alkyl, C₁—C₁₂-alkoxy or C₆—C₁₈-aryl group, where alkyl, alkoxy or aryl groups R^{c} and R^{d} may be substituted, independently of one another, by fluorine and/or chlorine atoms or R^{c} and R^{d} together with the carbon atom to which they are bound can form a C₃—C₁₂-cycloalkyl group which may be substituted by one or more C₁—C₆-alkyl groups, with at least one of Q, T and Y being different from —O— and at least one of Q, T and Y being —SO₂' and
Ar, Ar¹: independently of one another, a C₆—C₁₈-aryl group which may be substituted by C₁—C₁₂-alkyl, C₆—C₁₈-aryl or C₁—C₁₂-alkoxy groups or halogen atoms, and, in addition, comprise from 0.1 to 10% by weight, based on the total weight of the copolymer, of building blocks B which are derived from compounds having at least three hydroxy functions.

The preferred polyaryl ether copolymers are made up of recurring structural elements of the formula I or II, where Ar, Ar¹, m, n, t, q, Q, T and Y are as defined above, and building blocks B which are derived from compounds having at least three hydroxy functions. The at least three hydroxy functions present in the building blocks B in monomeric form are converted into ether functions on incorporation into the polymer chain.

In the polyaryl ether copolymers of the invention, the building blocks of the formulae I and II and the building blocks B can be present in any order. They can alternate strictly or be randomly distributed.

The polyaryl ether copolymers of the invention preferably correspond to the general formula III, where t, q, m, n, Q, T, Y, Ar and Ar¹ are as defined above and p is from 0 to 4.

B′ denotes building blocks B which are derived from compounds which have at least three hydroxy functions and may, if appropriate, be sulfonated.

x, y and z indicate the number of the individual blocks of the general formulae I, II and B, where x+y+z=1 and x is from 0.049 to 0.999, preferably from 0.095 to 0.945, particularly preferably from 0.1425 to 0.9425, y is from 0 to 0.95, preferably from 0.05 to 0.9, particularly preferably from 0.05 to 0.85, and z is from 0.001 to 0.1, preferably from 0.005 to 0.05, particularly preferably from 0.0075 to 0.03.

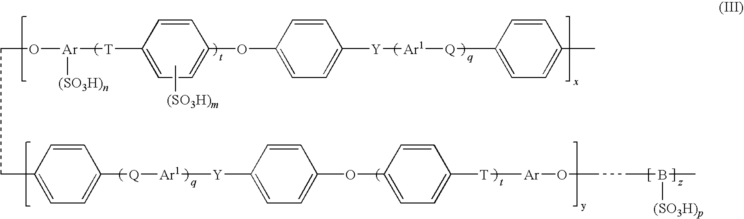

The blocks of the general formulae I, II or B present in the copolymer of the general formula III can be randomly distributed or can alternate strictly.

In a preferred embodiment, the building blocks of the general formulae I and II are each present in the polyaryl ether copolymers of the invention in a proportion of from 5 to 95 mol %, with the sum of the proportions of the building blocks of the general formulae I and II and B being 100 mol %.

In a preferred embodiment, Q, T and Y are each, independently of one another, —O— or —SO₂—.

Alkyl radicals which can be used according to the invention comprise straight-chain or branched, saturated hydrocarbon chains having up to 12 carbon atoms. The following radicals may be mentioned by way of example: C₁—C₆-alkyl radicals such as methyl, ethyl, n-propyl, i-propyl, n-butyl, sec-butyl, 2- or 3-methylpentyl and longer-chain radicals such as unbranched heptyl, octyl, nonyl, decyl, undecyl, lauryl and the singly or multiply branched analogues thereof. The alkyl part of the alkoxy groups which can be used according to the invention is defined as indicated above. Cycloalkyl radicals which can be used according to the invention comprise, in particular, C₃—C₁₂-cycloalkyl radicals, for example cyclopropyl, cyclobutyl cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, cyclopentylpropyl, cyclopentylbutyl, cyclopentylpentyl, cyclopentylhexyl, cyclohexylmethyl, cyclohexyldimethyl, cyclohexyltrimethyl and the like. Ar¹ is preferably unsubstituted C₆—C₁₂-aryl. Examples of C₆—C,₈-arylene groups Ar and Ar¹ which can be used according to the invention are phenylene groups such as 1,2-, 1,3- and 1,4-phenylene, naphthylene groups such as 1,6-, 1,7-, 2,6- and 2,7-naphthylene, and also the bridging groups derived from anthracene, phenanthrene and naphthacene.

In a particularly preferred embodiment, the polyaryl ether copolymers of the invention correspond to the general formula IV, where B, Ar, n, p, x, y and z are as defined above and the individual blocks can alternate or be randomly distributed.

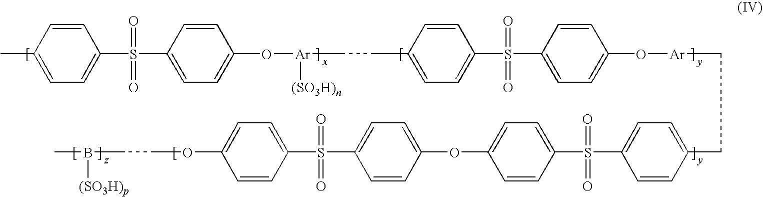

To prepare the polyaryl ether copolymers of the invention, the corresponding dihydroxy or dihalogen compounds, preferably the chlorine or fluorine compounds, are used as monomers. An example is the reaction of bis(chlorophenyl) sulfone with bis(hydroxyphenyl) sulfone and hydroquinone in the appropriate ratios in a polycondensation reaction with simultaneous liberation of hydrogen chloride.

The molar ratio of monomers having hydroxy functions to monomers having halogen functions is from 0.9:1.1 to 1.1:0.9, preferably from 0.95:1.05 to 1.05:0.95, particularly preferably 1:1. If various monomers having hydroxy functions or having halogen functions are present, these ratios apply in each case to the total molar amounts.

The reaction of the monomers in aprotic polar solvents in the presence of anhydrous alkali metal carbonate, for example sodium carbonate, potassium carbonate, calcium carbonate or mixtures thereof, is particularly useful. A particularly preferred combination is N-methylpyrrolidone as solvent and potassium carbonate as base.

The reaction of the appropriate monomers is carried out at a temperature of from 80. to 250° C., preferably from 100 to 220° C. The reaction is carried out for from 2 to 12 hours, preferably from 3 to 8 hours. After the polycondensation reaction is complete, a monofunctional alkyl or aryl halide, for example a C₁—C₆-alkyl chloride, bromide or iodide, preferably methyl chloride, or benzyl chloride, bromide or iodide or mixtures thereof can be added to the reaction mixture. These compounds react with the hydroxy groups at the end of the macromolecules and thus form the beginning and end units of the macromolecules.

The reaction in the melt is likewise preferred. The polycondensation in the melt is carried out at a temperature of from 140 to 290° C., preferably from 150. to 280° C.

Examples of building blocks of the general formula II present in the polyaryl ethers of the invention are building blocks comprising at least one of the following recurring structural units IIa to IIo:

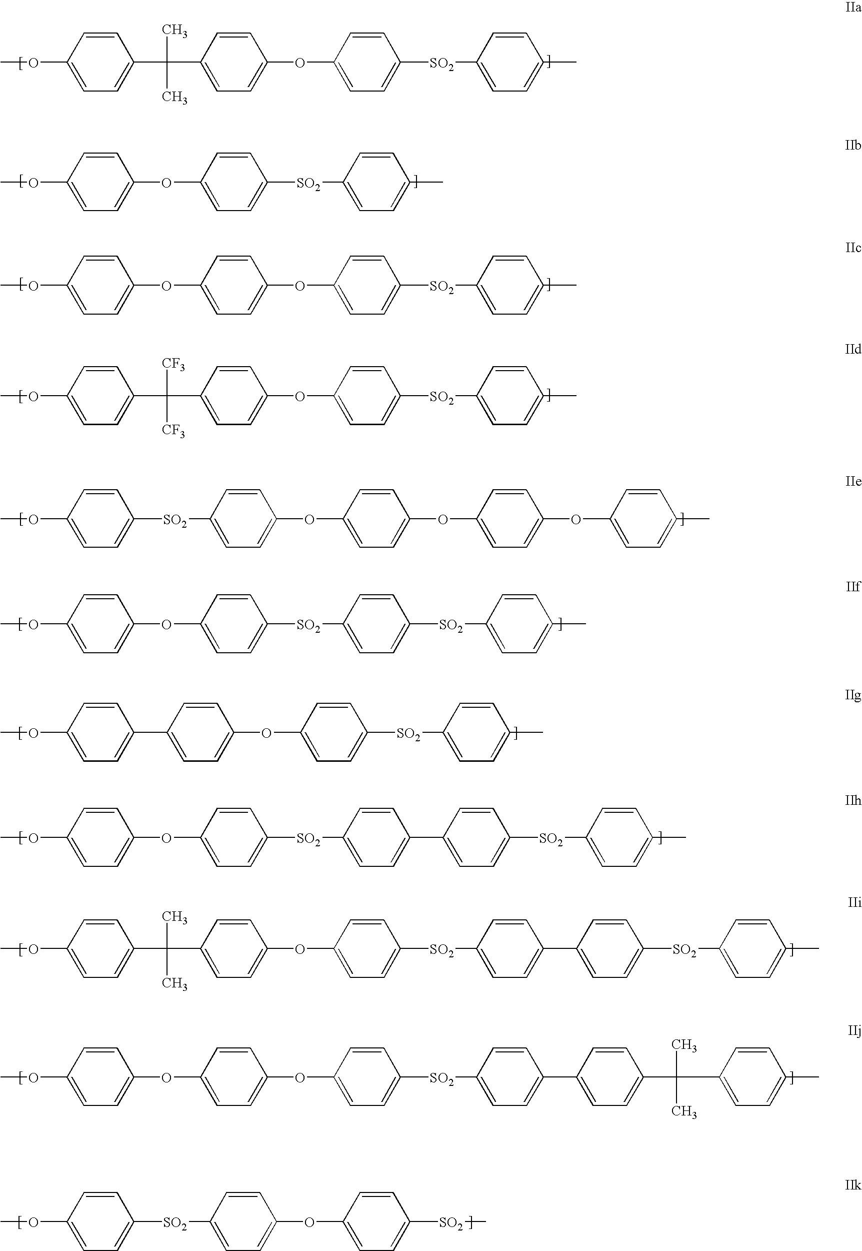

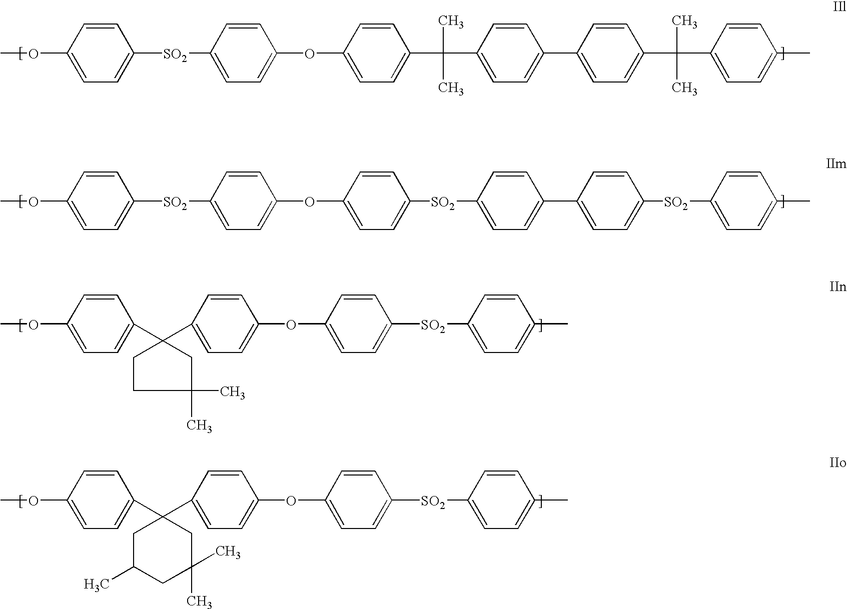

In addition to the building blocks IIa to IIo which are preferably present, preference is also given to building blocks in which one or more 1,4-dihydroxyphenyl units are replaced by resorcinol or dihydroxynaphthalene units.

The polyaryl ethers of the present invention can also be copolymers or block copolymers in which polyaryl ether segments and segments of other thermoplastic polymers, e.g. polyamides, polyesters, aromatic polycarbonates, polyester carbonates, polysiloxanes, polyimides or polyetherimides, we present. The molecular weights (number average) of the blocks or the graft arms in the copolymers are generally from 1000 to 30 000 g/mol.

The blocks of different structure can alternate or be randomly distributed in the copolymers. The proportion by weight of the polyaryl ethers in the copolymers or block copolymers is generally at least 10% by weight. The proportion by weight of the polyaryl ethers can be up to 97% by weight. Preference is given to copolymers or block copolymers having a proportion by weight of polyaryl ethers of up to 90% by weight. Particular preference is given to copolymers or block copolymers comprising from 20 to 80% by weight of polyaryl ethers.

Building blocks of the general formula I are also present in the branched polyaryl ether copolymers of the invention. These building blocks of the general formula I correspond to the presence of from 1 to 4 sulfonic acid groups (—SO₃H) on the structural unit Ar of the building blocks of the general formula II.

In a preferred embodiment, Ar is derived from an electron-rich aromatic substance which can readily be attacked electrophilically and is preferably selected from the group consisting of hydroquinone, resorcinol, dihydroxynaphthalene, for example 2,7-dihydroxynaphthalene, and 4,4′-bisphenol.

In the branched polyaryl ether copolymers of the invention, building blocks of the general formulae I and II which are identical if the presence of the sulfone groups is disregarded. However, it is also possible for building blocks of the general formulae I and II which additionally differ in the structure of the main polymer chain, i.e. in the meanings of t, q, Q, T, Y Ar and/or Ar¹, to be present.

In a preferred embodiment, the polyaryl ethers comprise, in addition to any further building blocks which can be used according to the invention, building blocks of the general formulae I and II which are identical in terms of the structure of the main polymer chain, i.e. t, q, Q, T, Y, Ar and Ar¹ have the same meanings in the building blocks of the formula I and of the formula II. In these preferred polyaryl ether copolymers, identical building blocks of which some are sulfonated on Ar (formula I) and some are not sulfonated on Ar (formula II) are thus present. The degree of sulfonation is from 20 to 300%, preferably from 30 to 150%. Values over 100% mean that the aromatic building blocks are multiply sulfonated.

The polyaryl ether copolymers of the present invention are branched. The branching of the main copolymer chains is achieved according to the invention by from 0.1 to 10% by weight, preferably from 0.5 to 7.5% by weight, particularly preferably from 1.0 to 6.0% by weight, very particularly preferably from 1.5 to 2.5% by weight, in each case based on the total weight of the copolymer, of building blocks B having at least 3 hydroxy functions being inserted in addition to the abovementioned building blocks of the general formulae I and II. These additional building blocks B are added in the polycondensation for producing the polyaryl ether copolymers and are incorporated like the dihydroxy compounds into the main polymer chain. The presence of at least one free hydroxy function on the additional building block B results in condensation of a suitable monomer with this at least one hydroxy function to form at least one branch on the main polymer chain. The building blocks B which can be used according to the invention can In monomeric form also have four hydroxy functions, so that two hydroxy functions are still available after incorporation into the main polymer chain to produce branching of the main chain.

The degree of branching of the polyaryl ether copolymers of the invention can be set via the amount of building blocks B which in monomeric form have at least three hydroxy functions and via the number of hydroxy functions present, viz. from three to five.

Examples of branching components of the type of the aromatic building blocks B in monomeric form which have at least three hydroxy functions are:

phloroglucin, 4,6-dimethyl-2,4,6-tri(4-hydroxyphenyl)hept-2-ene (=trimeric isopropenylphenol), 4,6-dimethyl-2,4,6-tri(4-hydroxyphenyl)heptane (=hydrogenated primary isopropenylphenol), 1,3,5-tri(4-hydroxyphenyl)benzene, 1,1,1-tri(4-hydroxyphenyl)ethane and 1,1,1-tri(4-hydroxyphenyl)propane, tetra(4-hydroxyphenyl)methane, 1,4-bis[(4′,4″-dihydroxytriphenyl)methyl]benzene and 2,2-bis[4,4′-bis(4-hydroxyphenyl)cyclohexyl]propane.

Trifunctional or more than trifunctional phenols which can be prepared by reaction of p-alkyl-substituted monophenols on unsubstituted o positions with formaldehyde or formaldehyde-releasing compounds, for example the trisphenol derived from p-cresol and formaldehyde, viz. 2,6-bis(2′-hydroxy-5′-methylbenzyl)-4-methylphenol, are particularly useful. Further examples which may be mentioned are: 2,6-bis(2′-hydroxy-5′-isopropylbenzyl)-4-isopropenylphenol and bis[2-hydroxy-3-(2′-hydroxy-5′-methylbenzyl-5-methylphenyl]methane.

Further suitable trifunctional and more than trifunctional phenols are those which have halogen atoms in addition to the phenolic hydroxyl groups, for example the halogen-comprising trihydroxyaryl ethers of the formula (V)

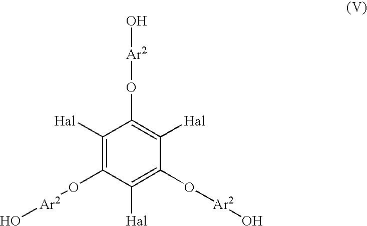

where Ar² is a monocyclic or polycyclic divalent aromatic radical and Hal Is chlorine or bromine. Examples of such compounds are:

1,3,5-tris(4-hydroxyphenoxy)-2,4,6-trichlorobenzene,

1,3,5-tris[4-(4-hydroxyphenylisopropyl)phenoxy]-2,4,6-trichlorobenzene,

1,3,5-tris[4-(4-hydroxy)biphenoxy]-2,4,6-trichlorobenzene,

1,3,5-tris[4-(4-hydroxyphenylsulfonyl)phenoxy]-2,4,6-trichlorobenzene and

1,3,5-tris[4-(4-hydroxyphenylisopropyl)phenoxy]-2,4,6-tribromobenzene.

The preparation of these compounds is described in the German published patent specification 1 768 620.

In a preferred embodiment, these building blocks which have at least 3 hydroxy functions are derived from 1,1,1-tris(4-hydroxyphenyl)ethane (VI)

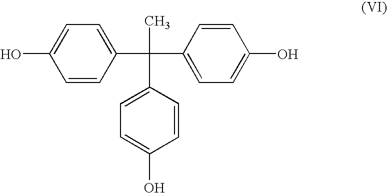

The present invention also provides a process for preparing the polyaryl ether copolymers of the invention by reacting polyaryl ether copolymers comprising building blocks of the general formula II and B with sulfuric acid.

The sulfuric acid which can be used according to the invention is used as a 50-98% strength solution in water. The reaction is carried out by dispersing the polyaryl ether copolymer to be sulfonated in an aqueous solution of sulfuric acid at a temperature of from 10 to 70° C., preferably from 15 to 50° C., particularly preferably from 20 to 30° C. This dispersion is stirred for from 1 to 12 hours, preferably from 2 to 10 hours, particularly preferably from 3 to 6 hours. During this time, the copolymer dissolves in the aqueous solution. After the reaction, the product is precipitated, preferably in water or a mixture of water and NMP. The isolation of the polyaryl ether copolymers of the invention is effected by methods known to those skilled in the art, for example decantation, filtration, centrifugation. After isolation, the product obtained is carefully washed with water until neutral.

The purification of the polyaryl ether copolymers of the invention is likewise carried out by methods known to those skilled in the art, for example, recrystallization or washing with suitable solvents in which the polyaryl ether copolymers are preferably largely insoluble.

The polyaryl ether copolymers of the invention have weight average molecular weights M_{w} of from 10 000 to 150 000 g/mol, preferably from 15 000 to 120 000 g/mol, particularly preferably from 18 000 to 100 000 g/mol.

The polyaryl ether copolymers of the invention have viscosity numbers measured in a 1% strength aqueous solution in N-methylpyrrolidone at 25° C. of from 30 to 200 ml/g, preferably from 35 to 190 ml/g, particularly preferably from 40 to 180 ml/g.

The present invention also provides polymer blends comprising at least one polyaryl ether copolymer according to the invention and at least one polymer selected from the group consisting of polyether sulfones, polysulfones, polyether ketones, polyetherimides, polyimides, polybenzimidazoles, polyamidimides and polyamides.

Further preferred blend components are: polyether sulfone, for example Ultrson® E (BASF Aktiengesellschaft), polysulfone, for example Ultrason® S (BASF Aktiengesellschaft), polyether ketone, for example Victrex® PEEK (Victrex Ltd.), polyetherimide, for example Ultem® (GE Plastics). Furthermore, hydrophilic polymers such as polyvinylpyrrolidone, polyethylene glycol and polyethylenimine are also possible.

The present invention also relates to the preparation of the polymer blends according to the invention by mixing of the polyaryl ether copolymers of the invention in solution with the further polymer or polymers, likewise in solution. For this purpose, the polyaryl ether copolymers and the appropriate further polymers are mixed by dissolving them in a joint medium, with dipolar aprotic solvents such as DMF, DMAC, NMP, DMSO, sulfolane, N-methylcaprolactam, ureas or mixtures thereof being particularly useful. The intimately mixed polymer blend is obtained by removal of the solvent.

Furthermore, it is also possible to isolate the respective polymer blends by precipitation from the joint solution. Further work-up and purification of these polymer blends are carried out by methods known to those skilled in the art, for example decantation, filtration or centrifugation and, if appropriate, washing and/or drying.

Due to the high mechanical strength and a high hydrophilicity, the polyaryl ether copolymers of the invention are particularly suitable for producing membranes which are subjected to severe mechanical and/or thermal conditions during production, further processing and/or use. An example which may be mentioned is production of a membrane for a fuel cell. In the production of a fuel cell, the membrane has to be clamped under the action of considerable forces. It must not tear as a result and must also not suffer any impairment which could lead to damage during later operation of the fuel cell. Further examples of applications in which the polyaryl ether copolymer of the invention can be used are ultrafiltration membranes or membranes for gas separation.

The present invention also provides for the use of a polyaryl ether copolymer according to the invention in the production of membranes, preferably membranes for fuel cells, ultrafiltration membranes or membranes for gas separation.

The present invention further provides membranes, preferably of fuel cells, for ultrafiltration or for the separation of gases, which comprise at least one polyaryl ether copolymer according to the invention.

The following examples illustrate the invention without restricting it.

### EXAMPLES

The viscosity number of the polyaryl ethers is determined in a 1% strength solution in N-methylpyrrolidone at 25° C.

The degree of sulfonation is determined by elemental analysis, and is reported as the proportion of sulfonated units, based on the comonomer, in %. Here, a value greater than 100% indicates that the unit is multiply sulfonated.

The sulfonated products were dissolved in DMF and placed on a glass plate. The solvent was slowly removed at 80° C., giving polymer membranes having a thickness of from 0.2 to 0.3 mm and a diameter of about 10 cm.

The water absorption is determined gravimetrically on membranes having a thickness of from 100 to 500 μm. For this purpose, pieces of membrane are teared and stored in deionized water for 7 days. The water absorption is determined after each 24 hours. After the end of the storage period, the membrane is dried to constant weight. The final weight of the membrane obtained after drying is used for calculating the degree of swelling.

The degree of swelling is given by:

Q=(weightₘₒᵢₛₜ/weight_{dry})*100%

3 samples of each material are stored and the mean of the 3 individual values is determined. The strength of the swollen membranes is determined by tensile experiments in accordance with ISO on films. For this purpose, 5 test specimens (“S3”) are stamped out of each material. The specimens are subsequently stored once again in deionized water for 24 hours, dabbed off and measured immediately.

### Preparation of the Polyaryl Ethers

Polyaryl ethers A1-A5

The polyaryl ethers A1-A5 are obtained by nucleophilic polycondensation. For this purpose, 1 mol (287.08 g) of bis(chlorophenyl) sulfone (DCDPS), (1-X-0.015 mol) of bis(hydroxyphenyl) sulfone, X mol of hydroquinone (HQ) and 0.01 mol, (9.18 g) of 1,1,1-tris(4-hydroxyphenyl)ethane are reacted in the presence of 143.76 g of potassium carbonate in 1000 ml of NMP. This mixture is kept at 195° C. for 6 hours. After cooling to 120° C., methyl chloride is passed into the solution for 1, hour. The mixture is then diluted by addition of 1000 ml of NMP, the solid constituents are separated off by filtration and the polymer is isolated by precipitation in NMP/water 1/9. After careful washing with water, the product is dried at 120° C. under reduced pressure for 12 hours. The viscosity number of the products, the composition and the glass transition temperature of the products are shown in Table 1.

Product AC was obtained without addition of 1,1,1-tris(4-hydroxyphenyl)ethane.

TABLE 1

| | | | DCDPS/ | |
|---|---|---|---|---|
| | X mol | VN | HQ units | |
| Product | of HQ | [ml/g] | [mol %] | T_{g} [° C.] |
| A1 | 0.05 | 75.6 | 5 | 228 |
| A2 | 0.1 | 78.7 | 11 | 226 |
| A3 | 0.2 | 76.5 | 20 | 224 |
| A4 | 0.35 | 74.0 | 36 | 222 |
| A5 | 0.5 | 79.1 | 51 | 221 |
| AC1 | 0.5 | 56.1 | 50 | 219 |

### Polyaryl Ethers A6-A10

The polyaryl ethers A6-A10 are obtained by nucleophilic polycondensation. For this purpose, 1 mol (287.08 g) of bis(chlorophenyl) sulfone, (1-X-0.015 mol) of bis(hydroxyphenyl) sulfone, X mol of 2,7-dihydroxynaphthalene (DHN) and 0.01 mol (9.18 g) of 1,1,1-tris(4-hydroxyphenyl)ethane are, reacted in the presence of 143.76 g of potassium carbonate in 1000 ml of NMP. This mixture is kept at 195° C. for 6 hours. After cooling to 120° C., methyl chloride is passed into the solution for 1 hour. The mixture is then diluted by addition of 1000 ml of NMP, the solid constituents are separated off by filtration and the polymer is isolated by precipitation in NMP/water 1/9. After careful washing with water, the product is dried at 120° C. under reduced pressure for 12 hours. The, viscosity number of the products, the composition and the glass transition temperature of the products are shown in Table 2.

Product AC2 was obtained without addition of 1,1,1-tris(4-hydroxyphenyl)ethane.

TABLE 2

| | | | DCDPS/ | |
|---|---|---|---|---|
| | X mol | VN | DHN units | |
| Product | of DHN | [ml/g] | [mol %] | T_{g} [° C.] |
| A6 | 0.05 | 70.6 | 5 | 229 |
| A7 | 0.1 | 71.7 | 11 | 228 |
| A8 | 0.2 | 72.5 | 21 | 226 |
| A9 | 0.35 | 71.9 | 34 | 224 |
| A10 | 0.5 | 69.1 | 50 | 223 |
| AC2 | 0.5 | 52.1 | 50 | 221 |

### Preparation of the Products According to the Invention

The components A were subsequently sulfonated. For this purpose, 10 g of polymer were dispersed in 80 ml of concentrated sulfuric acid (97%) at 25° C. All products dissolved completely within the chosen reaction time of 4 hours. The polymers were isolated by precipitation in 500 ml of water and filtered off. The products were washed 5 times with 200 ml each time of water on the frit, sucked dry and subsequently dried at 100° C. under reduced pressure for 24 hours. The degree of sulfonation of the samples obtained was determined by means of elemental analysis (increase in the S content). The viscosity number of the products was likewise determined in NMP.

An Ultrason E 6020 having a VN of 85.4 ml/g was likewise sulfonated. The properties of the products obtained are summarized in Table 3.

TABLE 3

| | | Degree of | Degree of | Tensile | Elongation |
|---|---|---|---|---|---|
| | VN | sulfonation | swelling | strength | at break |
| Product | [ml/g] | [%] | [%] | [MPa] | [%] |
| s-A1 | 79.3 | 46 | 2.9 | 68.2 | 10.1 |
| s-A2 | 81.2 | 67 | 4.1 | 66.1 | 12.4 |
| s-A3 | 84.2 | 73 | 5.9 | 61.4 | 15.7 |
| s-A4 | 86.2 | 78 | 8.1 | 54.4 | 16.7 |
| s-A5 | 89.1 | 74 | 9.1 | 50.6 | 19.1 |
| s-AC1 | 62.1 | 69 | 8.4 | 43.6 | 8.9 |
| s-U-son E | 86.2 | 0 | 2.3 | 69.9 | 8.3 |
| s-A6 | 74.1 | 146 | 4.1 | 62.1 | 9.7 |
| s-A9 | 83.4 | 143 | 15.2 | 45.1 | 14.7 |
| s-AC2 | 59.1 | 136 | 14.1 | 37.1 | 6.8 |

The products according to the invention have a high water absorption and a good tensile strength. In addition, the elongation at break in the moist state is significantly higher in the case of the branched products according to the invention than in the case of the linear products. Surprisingly, the products according to the invention also display a significantly higher water absorption.

1. A branched polyaryl ether copolymer which is made up of the building blocks of the general formulae I and II 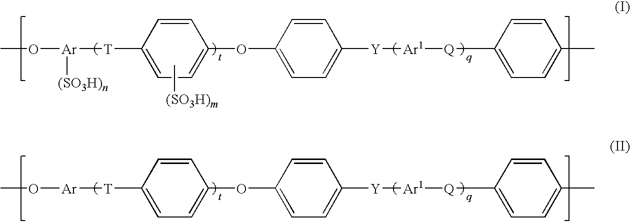
where
t, q: independently of one another, 0, 1, 2 or 3,
m: from 0 to 4,
n: from 1 to 4,
Q, T, Y: independently of one another, each a chemical bond or group selected from among —O—, —S—, —SO₂—, S═O, C═O, —N═N—, —R^{a}C═CR^{b}, —CR^{c}R^{d}—, where R^{a} and R^{b} are each, independently of one another, a hydrogen atom or a C₁—C₁₂-alkyl group and R^{c} and R^{d} are each, independently of one another, a hydrogen atom or a C₁—C₁₂-alkyl, C₁—C₁₂-alkoxy or C₆—C₁₈-aryl group, where alkyl, alkoxy or aryl groups R^{c} and R^{d} may be substituted, independently of one another, by fluorine and/or chlorine atoms or R^{c} and R^{d} together with the carbon atom to which they are bound can form a C₃—C₁₂-cycloalkyl group which may be substituted by one or more C₁—C₆-alkyl groups, with at least one of Q, T and Y being different from —O— and at least one of Q, T and Y being —SO₂— and
Ar, Ar¹: independently of one another, a C₆—C₁₈-aryl group which may be substituted by C₁—C₁₂-alkyl, C₆—C₁₈-aryl or C₁—C₁₂-alkoxy groups or halogen atoms,
and, in addition, comprise from 0.1 to 10% by weight, based on the total weight of the copolymer, of building blocks B which are derived from compounds having at least three hydroxy functions.

2. The polyaryl ether copolymer according to claim 1, wherein Q, T and Y are each, independently of one another, —O— or —SO₂—.

3. The polyaryl ether copolymer according to claim 1, wherein Ar¹ is selected from the group consisting of hydroquinone, resorcinol, dihydroxynaphthalene and 4,4′-bisphenol.

4. The polyaryl ether copolymer according to claim 1, wherein Ar¹ is unsubstituted C₆—C₁₂-aryl.

5. The polyaryl ether copolymer according to claim 1, wherein building blocks of the general formulae I and II are each present in a proportion of from 5 to 95 mol %, with the sum of the proportions of the building blocks of the general formulae I and II and B being 100 mol %.

6. A process for preparing polyaryl ether copolymers according to claim 1 by reacting polyaryl ether copolymers made up of building blocks of the general formula II and B with sulfuric acid.

7. A polymer blend comprising at least one polyaryl ether copolymer according to claim 1 and at least one polymer selected from the group consisting of polyether sulfones, polysulfones, polyether ketones, polyetherimides, polyimides, polybenzimidazoles, polyamidimides and polyamides.

8. A process for preparing polymer blends as defined in claim 7, wherein branched polyaryl ether copolymers which are made up of the building blocks of the general formulae I and II 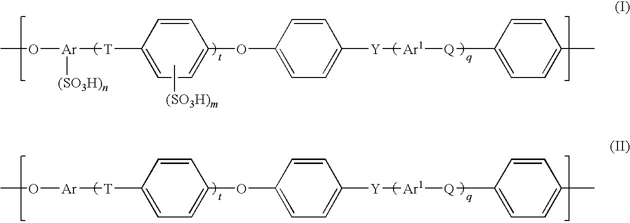
where
t, q: independently of one another, 0, 1, 2 or 3,
m: from 0 to 4,
n: from 1 to 4,
Q, T, Y: independently of one another, each a chemical bond or group selected from among —O—, —S—, —SO₂—, S═O, C═O, —N═N—, —R^{a}C═CR^{b}, —CR^{c}R^{d}—, where R^{a} and R^{b} are each, independently of one another, a hydrogen atom or a C₁—C₁₂-alkyl group and R^{c} and R^{d} are each, independently of one another, a hydrogen atom or a C₁—C₁₂-alkyl, C₁—C₁₂-alkoxy or C₆—C₁₈-aryl group, where alkyl, alkoxy or aryl groups R^{c} and R^{d} may be substituted, independently of one another, by fluorine and/or chlorine atoms or R^{c} and R^{d} together with the carbon atom to which they are bound can form a C₃—C₁₂-cycloalkyl group which may be substituted by one or more C₁—C₆-alkyl groups, with at least one of Q, T and Y being different from —O— and at least one of Q, T and Y being —SO₂— and Ar, Ar¹: independently of one another, a C₆—C₁₈-aryl group which may be substituted by C₁—C₁₂-alkyl, C₆—C₁₈-aryl or C₁—C₁₂-alkoxy groups or halogen atoms,
and, in addition, comprise from 0.1 to 10% by weight, based on the total weight of the copolymer, of building blocks B which are derived from compounds having at least three hydroxy functions are mixed in solution with the further polymer or polymers, likewise in solution.

9. The method of using a polyaryl ether copolymer according to claim 1 in the production of membranes.

10. A membrane comprising at least one polyaryl ether copolymer according to claim 1.

11. A fuel cell membrane comprising at least one polyaryl ether copolymer according to claim 1.

12. A ultrafiltration membrane comprising at least one polyaryl ether copolymer according to claim 1.

13. A gas separation membrane comprising at least one polyaryl ether copolymer according to claim 1.
